(19) United States
(12) Patent Application Publication
(10) Pub. No.: US 2017/0353636 A1
(43) Pub. Date: Dec. 7, 2017

(54) TRI-LENS IMAGE CAPTURING DEVICE

(71) Applicant: Ancil Bishop, Davie, FL (US)

(72) Inventor: Ancil Bishop, Davie, FL (US)

(21) Appl. No.: 15/172,458

(22) Filed: Jun. 3, 2016

(51) Int. Cl. H04N 5/225; G02B 7/02; H04N 5/232

(52) U.S. Cl. CPC H04N 5/2254; H04N 5/23293; H04N 5/23241; G02B 7/021; H04N 5/2252; H04N 5/23238

(57) ABSTRACT

A tri-lens image capturing device for obtaining images in up to a 360 degree field of view includes a camera that has a housing and a fixed lens. A right side lens and a left side lens are operationally coupled to the camera. The right side lens is positioned on a right side of the housing. The left side lens is positioned on a left side of the housing. A control panel is positioned on the housing and is operationally coupled to the camera, the right side lens and the left side lens.

### BACKGROUND OF THE DISCLOSURE

### Field of the Disclosure

The disclosure relates to image capturing devices and more particularly pertains to a new image capturing device for obtaining images in up to a 360 degree field of view.

### SUMMARY OF THE DISCLOSURE

An embodiment of the disclosure meets the needs presented above by generally comprising a camera that has a housing and a fixed lens. A right side lens and a left side lens are operationally coupled to the camera. The right side lens is positioned on a right side of the housing. The left side lens is positioned on a left side of the housing. A control panel is positioned on the housing and is operationally coupled to the camera, the right side lens and the left side lens.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of a tri-lens image capturing device according to an embodiment of the disclosure.

FIG. 2 is a back view of an embodiment of the disclosure.

FIG. 3 is a side view of an embodiment of the disclosure.

FIG. 4 is a bottom view of an embodiment of the disclosure.

FIG. 5 is a front view of an embodiment of the disclosure.

### DESCRIPTION OF THE PREFERRED EMBODIMENT

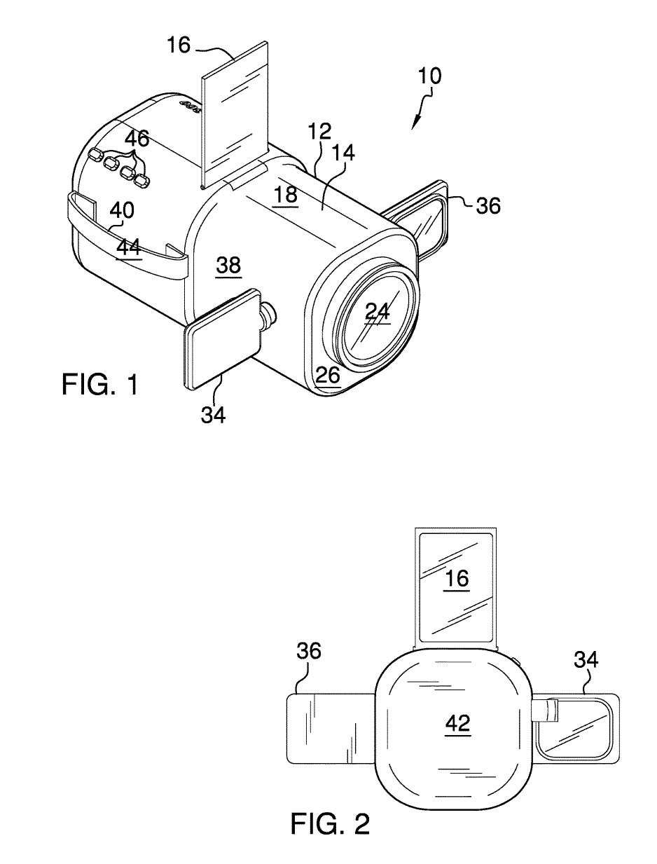

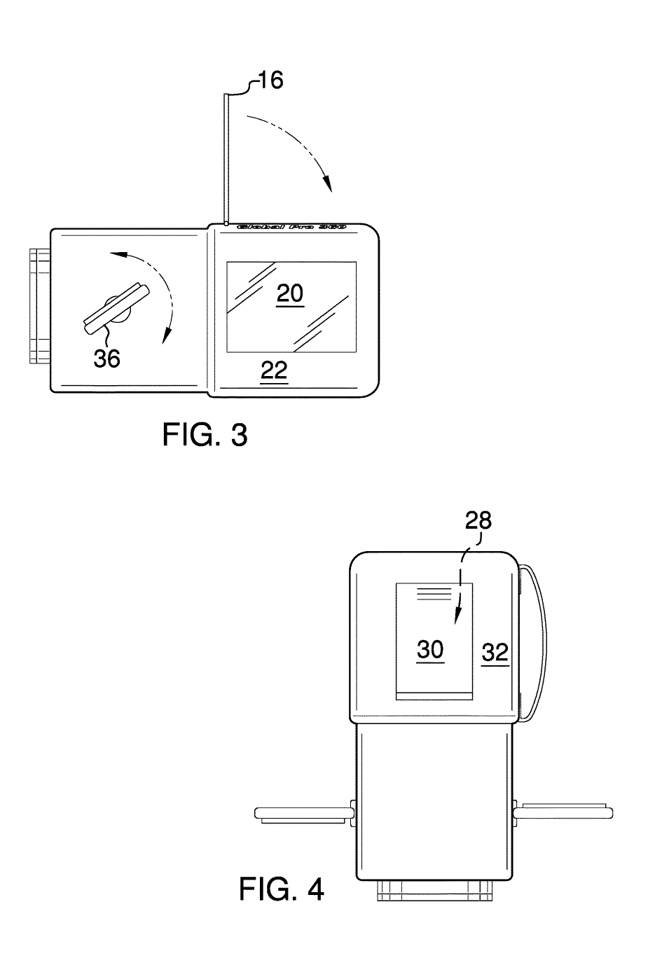

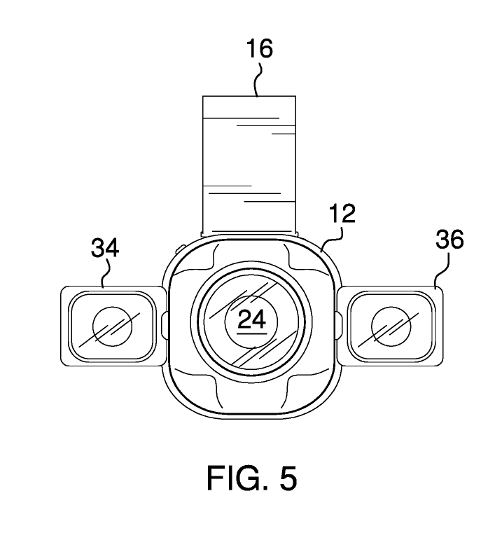

With reference now to the drawings, and in particular to FIGS. 1 through 5 thereof, a new image capturing device embodying the principles and concepts of an embodiment of the disclosure and generally designated by the reference numeral 10 will be described.

As best illustrated in FIGS. 1 through 5, the tri-lens image capturing device 10 generally comprises a camera 12 that has a housing 14. A monitor 16 is coupled to the housing 14. Preferably, the monitor 16 is hingedly coupled to a top 18 of the housing 14. A display 20 is coupled to the housing 14, preferably to a left side 22 of the housing 14. A fixed lens 24 is positioned in a front 26 of the housing 14. A power module 28 is position in and coupled to the housing 14. The power module 28 comprises at least one battery. An access panel 30 is positioned in a bottom 32 of the housing 14 proximate to the power module 28.

A right side lens 34 and a left side lens 36 are operationally coupled to the camera 12. The right side lens 34 is positioned on a right side 38 of the housing 14. The left side lens 36 is positioned on the left side 22 of the housing 14. Preferably, the right side lens 34 is positioned on the right side 38 of the housing 14 proximate to the front 26, and the left side lens 36 is positioned on the left side 22 of the housing 14 proximate to the front 26. The right side lens 34 and the left side lens 22 are rotationally attached to the housing 14. Preferably, the right side lens 34 and the left side lens 36 are both hingedly and rotationally attached to the housing 14. A handle 40 is positioned on the housing 14, preferably on the right side 38 of the housing 14 and proximate to a back 42 of the housing 14. The handle 40 may be a strap handle 44. A control panel 46 is positioned on the housing 14 and is operationally coupled to the camera 12, the right side lens 34 and the left side lens 36. The control panel 46 is positioned on the housing 14 proximate to the back 42 of the housing 14. The improvement is the right side lens 34 and the left side lens 36. The right side lens 34 and the left side lens 36 are positioned relative to the fixed lens 24 to allow the user to capture still and video images in a 360 field of view.

In use, the right side lens 34 and the left side lens 36 are positioned to capture still and video images that, in combination with the images captured by the front lens 24, comprise up to a 360 degree field of view.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A tri-lens image capturing device, said device comprising:
a camera, said camera having a housing, said camera having a fixed lens;
a right side lens and a left side lens, said right side lens and said left side lens being operationally coupled to said camera, said right side lens being positioned on a right side of said housing, said left side lens being positioned on a left side of said housing;
a control panel, said control panel being positioned on said housing, said control panel being operationally coupled to said camera, said right side lens and said left side lens; and
wherein the improvement is said right side lens and said left side lens, said right side lens and said left side lens being positioned relative to said fixed lens to allow the user to capture still and video images in a 360 field of view.

2. The device of claim 1, further including said camera comprising:
said fixed lens being positioned in a front of said housing;
a monitor, said monitor being coupled to said housing;
a display, said display being coupled to said housing;
a power module, said power module being position in and coupled to said housing; and
an access panel, said access panel being positioned in a bottom of said housing proximate to said power module

3. The device of claim 2, further including said monitor being hingedly coupled to a top of said housing.

4. The device of claim 2, further including said display being coupled to said left side of said housing;

5. The device of claim 2, further including said power module comprising at least one battery.

6. The device of claim 1, further comprising:
said right side lens being positioned on said right side of said housing proximate to a front of said housing; and
said left side lens being positioned on said left side of said housing proximate to said front.

7. The device of claim 1, further including said right side lens and said left side lens being rotationally attached to said housing.

8. The device of claim 1, further including said right side lens and said left side lens being hingedly and rotationally attached to said housing.

9. The device of claim 1, further including a handle, said handle being positioned on said housing.

10. The device of claim 9, further including said handle being positioned on said right side of said housing proximate to a back of said housing.

11. The device of claim 10, further including said handle being a strap handle.

12. The device of claim 1, further including said control panel being positioned on said housing proximate to a back of said housing.

13. A tri-lens image capturing device, said device comprising:
a camera, said camera comprising:
a housing,
a monitor, said monitor being coupled to said housing, said monitor being hingedly coupled to a top of said housing,
a display, said display being coupled to said housing, said display being coupled to a left side of said housing,
a fixed lens, said fixed lens being positioned in a front of said housing,
a power module, said power module being position in and coupled to said housing, said power module comprising at least one battery,
an access panel, said access panel being positioned in a bottom of said housing proximate to said power module
a right side lens and a left side lens, said right side lens and said left side lens being operationally coupled to said camera, said right side lens being positioned on a right side of said housing, said left side lens being positioned on said left side of said housing, said right side lens being positioned on said right side of said housing proximate to said front, said left side lens being positioned on said left side of said housing proximate to said front, said right side lens and said left side lens being rotationally attached to said housing, said right side lens and said left side lens being hingedly and rotationally attached to said housing;
a handle, said handle being positioned on said housing, said handle being positioned on said right side of said housing, said handle being positioned proximate to a back, said handle being a strap handle; and
a control panel, said control panel being positioned on said housing, said control panel being operationally coupled to said camera, said right side lens and said left side lens, said control panel being positioned on said housing proximate to said back of said housing; and
wherein the improvement is said right side lens and said left side lens, said right side lens and said left side lens being positioned relative to said fixed lens to allow the user to capture still and video images in a 360 field of view.
